(19) United States
(12) Patent Application Publication
(10) Pub. No.: US 2008/0301570 A1
(43) Pub. Date: Dec. 4, 2008

(54) SPACIOTEMPORAL GRAPHICAL USER INTERFACE FOR COLLABORATIVE AND SECURE INFORMATION SHARING

(76) Inventors: James M. Milstead, Madison, AL (US); Gregory P. Bowman, Madison, AL (US); Brett L. Bennett, Seattle, WA (US)

Correspondence Address: DUKE W. YEE, YEE & ASSOCIATES, P.C., P.O. BOX 802333, DALLAS, TX, 75380, US

(21) Appl. No.: 11/757,165

(22) Filed: Jun. 1, 2007

(51) Int. Cl. G06F 15/16; G06F 3/048

(52) U.S. Cl. 715/763; 726/14

(57) ABSTRACT

A collaborative information sharing system as described herein employs a graphical user interface (GUI) that displays a spaciotemporal rendering along with icons that represent items of interest, such as aircraft, vessels, radar equipment, and communications equipment. The GUI is also used to display item data that describes, defines, or identifies the items of interest. The item data may be provided by multiple information sources residing in different network security domains. The system combines item data governed by disparate security protocols in a manner that allows users having different security credentials to collaborate and share the information while still providing the required security and data protection.

### TECHNICAL FIELD

Embodiments of the subject matter described herein relate generally to collaborative information sharing systems. More particularly, embodiments of the subject matter relate to a spaciotemporal graphical user interface (GUI) for a collaborative information sharing system.

### BACKGROUND

It is often desirable for different and unrelated information users, consumers, and/or producers to share information or data in a collaborative manner (where an information user, consumer, or producer can be a person, a business entity, a law enforcement agency, a government intelligence agency, an educational facility, an administrative body, or the like). For example, commercial air traffic controllers and military intelligence agencies might need to share information related to the real time status of aircraft within a specified airspace. In practice, however, it can be challenging to facilitate efficient and effective information sharing between disparate and unrelated users who have a need to collaborate to understand and respond to certain situations in real time (e.g., a real world crisis, a natural disaster, or an enemy attack). Such collaborative information sharing can be inhibited by the untimely sharing of protected (e.g., confidential or classified) and unprotected (e.g., unclassified) information, and by vague or unclear communications while attempting to share information.

The timely flow of relevant information is typically handled by establishing a priori agreements about the conditions and the technical methods by which information can be shared between two or more operators, analysts, or decision makers. When sharing is allowed, strict, manually applied access rules can limit the frequency, volume, and consistency of data transferred. Recent advances in information sharing technologies are opening new opportunities for information sharing between information consumers, particularly when the shared information originates from disparate sources having different security measures and data access criteria. With an increase in information sharing, however, comes an increased need to provide clear and immediate context and filtering of the information being shared. In this regard, it is often desirable to indicate the physical locations of the information sources and/or to provide temporal information for shared information (i.e., indicate when the information was generated).

During a crisis situation information is made available to numerous operators, analysts, decision makers, and other users of information, with only a very limited number of entities having actual knowledge of how that information is related to the current issue. In other words, although many different types of information from many different sources may be currently available, it may be difficult for any one user or entity to be truly aware of the context of each piece of information and/or the context of the collective information as a whole (the “big picture” view). Even if context is communicated by one party to another, lack of familiarity with potentially disparate methods of operation often makes the information appear to be unclear or vague to the receiving party. Accordingly, even when information sharing rules are painstakingly established and a working physical communication network is built between parties, they are very often unable to establish meaningful dialogue during crisis situations. Indeed, despite the availability of best-in-class communication systems and highly trained operators, information and data may be difficult to intelligently interpret without proper context.

Current systems that attempt to manage the context of shared information with a computer generated user interface typically adopt the format and protocols of only one of the information users, and such systems usually have a steep user learning curve. Employing a widely understood and deployed user interface ensures a common contextual foundation, but such use may be inappropriate for the sharing of protected information that might originate from a party that has not adopted the same format and protocols for the information.

### BRIEF SUMMARY

The techniques and technologies described herein relate to a collaborative information sharing system and related operating methods. The information sharing system utilizes GUIs that fuse together geospatial and temporal information with descriptive information relevant to an item or items of interest in an easy to understand contextual manner. The information sharing system also employs multi-level security techniques for the access and display of protected information.

The above and other features may be carried out by an embodiment of a collaborative information sharing system. The system includes: an information source that provides item data related to an item of interest, the item data being governed by a security protocol; a server coupled to the information source, and configured to route the item data to user devices in accordance with the security protocol; and a user device coupled to the server, the user device being configured to receive the item data from the server. The user device is configured to render a GUI that is influenced by the item data. The GUI includes a spaciotemporal rendering of an area of interest, and an icon superimposed on the spaciotemporal rendering, where the icon represents the item of interest.

The above and other aspects may be carried out by an embodiment of a method of displaying a representation of an item of interest to facilitate collaborative information sharing for the item of interest. The method involves: obtaining item data related to the item of interest, the item data originating from disparate security domains; granting access to the item data in accordance with security credentials of an authenticated user, and in accordance with different security protocols utilized by the disparate security domains; generating a spaciotemporal rendering of an area of interest; generating an icon representing the item of interest; and rendering a GUI on a display of an electronic device. The GUI includes the spaciotemporal rendering and the icon superimposed on the spaciotemporal rendering, and the GUI is influenced by the item data.

The above and other aspects may be carried out by an embodiment of a method of displaying, on an electronic display of a device, a representation of an item of interest to facilitate collaborative information sharing for the item of interest. The method involves: authenticating a user of the device to establish a data filtering criteria for the user; obtaining, at the device, item data related to the item of interest, the item data originating from disparate security domains, and the item data satisfying the data filtering criteria; displaying, on the electronic display, a spaciotemporal rendering of an area of interest; displaying, on the electronic display and within the spaciotemporal rendering of the area of interest, an icon that represents the item of interest; and displaying, on the electronic display, content derived from the item data.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a network-based collaborative information sharing system;

FIG. 2 is another schematic representation of an embodiment of a network-based collaborative information sharing system;

FIG. 3 is a schematic representation of an embodiment of an electronic device that is suitable for use with a collaborative information sharing system;

FIG. 4 is a flow chart that illustrates a collaborative information display process; and

FIGS. 5-10 depict exemplary GUIs generated by a collaborative information sharing system.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of data transmission protocols and that the system described herein is merely one suitable example.

Embodiments of the invention may also be described herein with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits.

As used herein, a “server” is often defined as a computing device or system configured to perform any number of functions and operations associated with the management, processing, storage, retrieval, and/or delivery of data, particularly in a network environment. Alternatively, a “server” or “server application” may refer to software or firmware that performs such processes, methods, and/or techniques. As in most commercially available general purpose computing devices, a practical computing architecture used for a server may be configured to run on any suitable operating system such as Unix, Linux, the Apple Macintosh OS, any variant of Microsoft Windows, a commercially available real time operating system, or a customized operating system, and it may employ any number of processors, e.g., the Pentium family of processors by Intel, the processor devices commercially available from Advanced Micro Devices, IBM, Sun Microsystems, or Motorola, or other commercially available embedded microprocessors or microcontrollers.

When implemented in software or firmware, various elements of the system described herein (which may be realized in the different hardware components of the system) are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. Indeed, the code segments may be downloaded via computer networks such as the internet, an intranet, a LAN, or the like.

For the sake of brevity, conventional techniques related to data transmission, signaling, network control, GUI generation and rendering, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the subject matter.

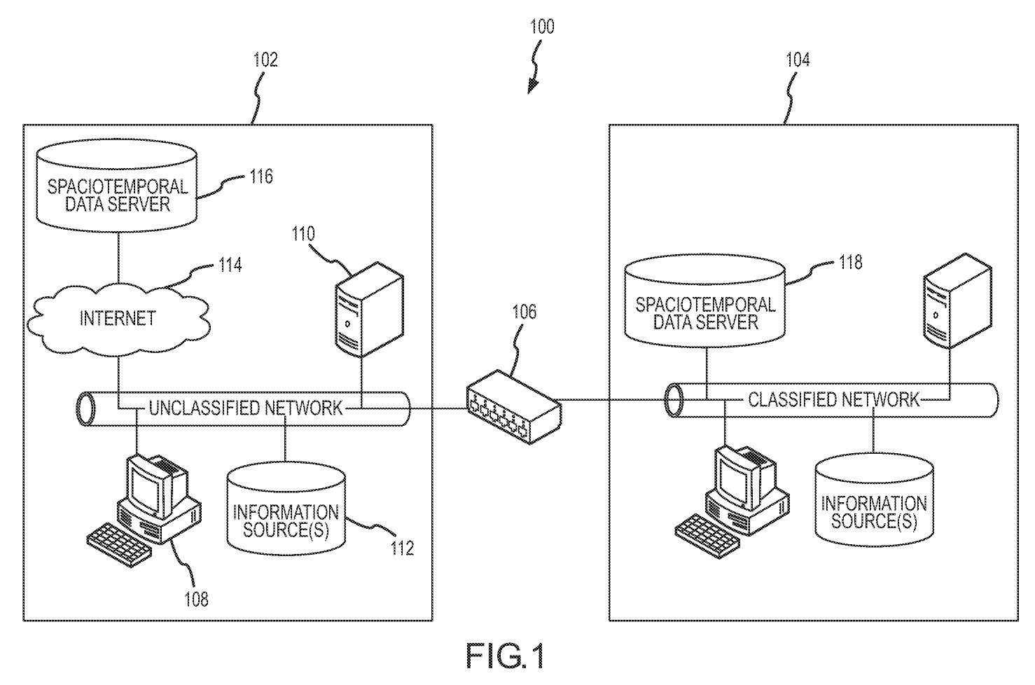

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematics shown in FIGS. 1-3 depict exemplary arrangements of elements, additional intervening elements, devices, features, or components may be present in an embodiment of the depicted subject matter.

The embodiment of the collaborative information sharing system described herein is implemented in a computer network architecture. The system is capable of integrating known information about a given item or grouping of items of interest (e.g., a ship, an aircraft, a building, a train, a person, or the like) using a GUI along with available intelligence gathering and response resources, which may be underwater, sea, land, air, space, or knowledge-based resources. The system maintains and applies rules and protocols regarding the security levels of the various attributes of items of interest and the information related to the items of interest, within a common and intuitive contextual environment. This enables the system to increase the granularity of permissions to view specific items of interest and attribute information corresponding to the items of interest. The system also provides a message-based mechanism for communicating information about the items of interest within and among computer networks of various security classifications (e.g., secured networks used by or for law enforcement agencies, classified government agencies, foreign governments, export restricted data or goods, proprietary business data, etc.). The system provides a temporally sensitive mechanism for viewing information in real time, near real time, or in any window of time where historical information known during that window of time is “replayed” to the viewer.

The embodiment of the collaborative information sharing system described herein provides several real world benefits. For example, the system has increased communications capabilities for selective distribution of sensitive information between diverse user groups with or without a priori data sharing agreements in place. In addition, the system improves communication efficiency and bandwidth by handling and transmitting focused geospatial, temporal, and sensitive data and information in a manner that is specifically tailored to end user credentials and permissions. The system can be used to display information in an on-demand fashion or persistently, as desired. Moreover, the system can be deployed in a completely service oriented architecture where each software component in the overall architecture is completely decoupled from all of the other components, so that such components can be replaced, removed, or upgraded without any impact to each other. Furthermore, the GUI generated by the system can be designed to easily accommodate data and information provided by existing sources.

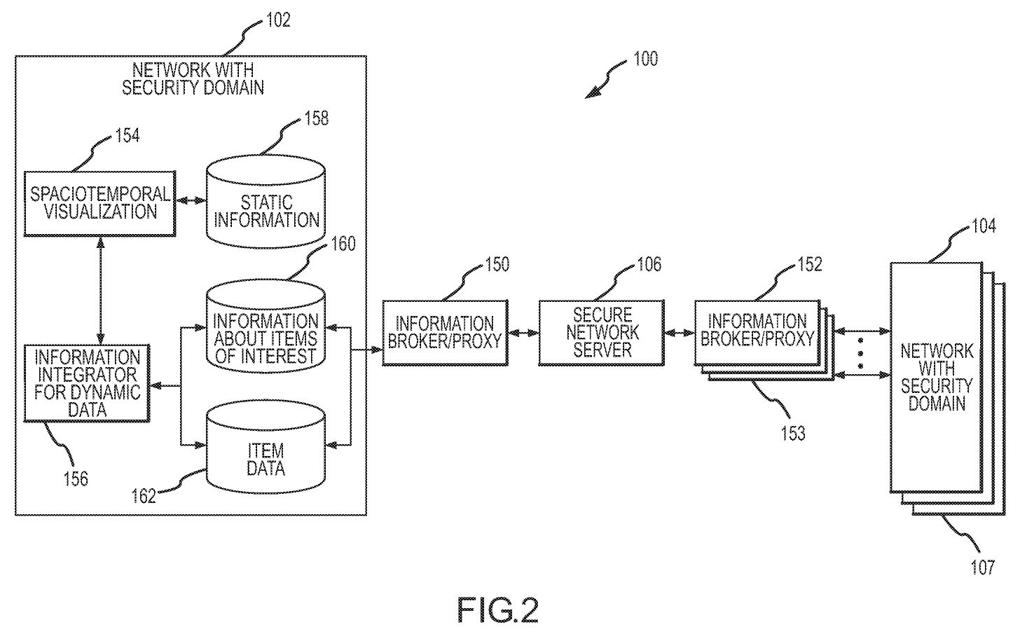

FIG. 1 is a schematic representation of an embodiment of a network-based collaborative information sharing system 100, and FIG. 2 is another schematic representation of system 100. For ease of description, system 100 is illustrated in an overly simplified manner; a practical embodiment of system 100 can be configured to support any number of different networks, any number of information sources, any number of user devices, and any number of users (restricted only by realistic and practical operating limitations). System 100 includes a first network 102, a second network 104, and a secure network server 106 coupled between first network 102 and second network 104. Secure network server 106 generally functions as an interface and data router between the various networks. Additional details of secure network server 106 are described below. As depicted in FIG. 2, system 100 may include any number of additional networks 107 coupled to secure network server 106.

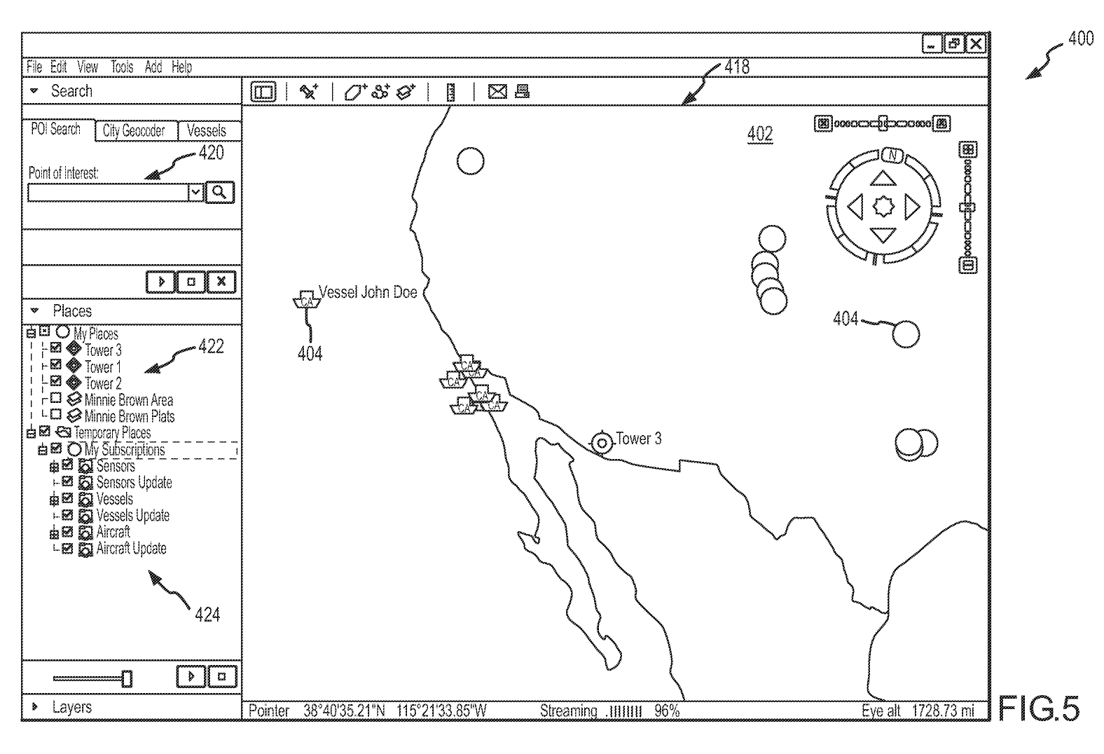

FIG. 5 depicts an exemplary GUI 400 generated by a user device within system 100. GUI 400 is rendered on an electronic display of the user device and/or on an electronic display that is coupled to the user device. GUI 400 generally includes a spaciotemporal rendering 402 of an area of interest (the western United States in the snapshot shown in FIG. 5). In addition, GUI 400 includes one or more icons 404 that indicate various items of interest, where such icons 404 are superimposed on spaciotemporal rendering 402. In certain embodiments of system 100, each displayed icon 404 represents a different item of interest, such as, without limitation: a ship; an aircraft; a building; a train; military equipment; a sensor; a person; an animal; a business, government, or personal asset; a document; a radar station; a telecommunications antenna; or the like). An item of interest has “item data” associated therewith, where item data may be data that describes, defines, or otherwise indicates a characteristic, trait, status, or state of the item of interest. For example, item data may represent, without limitation: current, past, or future location/tracking information for an item of interest; user-generated information related to an item of interest; a geographical boundary associated with an item of interest (e.g., the broadcast range of an antenna or the operating range of a radar system); navigational data for an item of interest; a status or state of an item of interest (e.g., “friend or foe” status); a name or identifier of an item of interest; an area of jurisdiction; applicable rules of engagement; a strike range; an expected response time; or a relationship or set of relationships between two or more items of interest. GUI 400 displays or makes available the current item data corresponding to the displayed icons 404. In this regard, GUI 400 is influenced by the item data. GUI 400 and other exemplary GUIs are described in more detail below.

Referring again to FIG. 1 and FIG. 2, a network within system 100 may be any suitably configured topology of computing devices, peripheral devices, memory storage devices, data communication links, and other hardware, software, and/or firmware. A network within system 100 may include any number of wireless and/or wired electronic devices, which may communicate using wireless and/or wired data communication links. In this regard, a network within system 100 represents a computer network as commonly defined in its broadest sense, and well known and conventional aspects of computer networks will not be described here.

For the exemplary embodiment described herein, a given network within system 100 is associated with a particular security domain, where a “security domain” represents limitation of access to a set of users with a shared need to know. Examples include, without limitation: military classifications; medical or financial record access security levels; and business proprietary data access security levels. As depicted in FIG. 1, network 102 represents an unclassified network domain, while network 104 represents a classified network domain. Some information and data generated within unclassified network 102, some information and data stored or provided by network 102, certain users of network 102, and certain communications originating from network 102 may be governed by a particular security protocol that provides relatively open access (in other words, a “security protocol” as used herein may represent little security or no security whatsoever). In contrast, some information and data generated within classified network 104, some information and data stored or provided by network 104, certain users of network 104, and certain communications originating from network 104 may be governed by a different security protocol that provides relatively limited and strict access. In practice, a given authenticated user of system 100 may be an individual with specific security credentials (e.g., a secret clearance, a top secret clearance, a civilian status, federal student aid “6C” clearance, or the like). System 100 can process the security credentials and apply the different security protocols and security measures used by the disparate networks to grant/deny access to data by that user. Thus, system 100 can allow a user with top secret credentials to access and view information designated as “top secret” along with information designated as being less secure. On the other hand, for an individual having no classified status whatsoever, system 100 can restrict access to any classified materials. In this manner, system 100 establishes data/information filtering criteria for the end users to ensure that the expected levels of protection and security are maintained for information available on system 100. In operation, system 100 utilizes the different security protocols of the network security domains along with user authentication data to effectively filter (i.e., block or screen) information such that a given user can only access certain types, classes, or categories of information.

For the simplified embodiment shown in FIG. 1, unclassified network 102 includes at least one user device 108, at least one network server 110, and at least one information source 112 (e.g., a database server). Unclassified network 102 may include or communicate with another network such as the internet 114, which in turn communicates with a spaciotemporal data server 116 that provides spaciotemporal data utilized for the spaciotemporal renderings displayed by user devices. Information source 112 provides item data related to items of interest being monitored by users of system 100. Such item data may be governed by a particular security protocol and specific security measures, as described herein. Briefly, user device 108, which may be any suitably configured electronic device having an electronic display associated therewith, is configured to receive item data from secure network server 106 upon successful user authentication, and to render a GUI (such as GUI 400) that is influenced by the item data. Spaciotemporal data server 116 supports user device 108, and it contains static information associated with the spaciotemporal characteristics of an area of interest being monitored by system 100 (FIG. 2 alternatively depicts such static information in a database 158). Network server 110 runs one or more applications that support the operation of network 102 and facilitate communication between network 102 and other networks in system 100, via secure network server 106. For example, network server 110 may run an application that publishes messages through secure network server 106 to a corresponding network server in classified network 104, which subscribes to the published messages.

Classified network 104 is similar in configuration to unclassified network 102, however, classified network 104 includes its own spaciotemporal data server 118, which resides within the protected security domain of classified network 104. In other words, classified network 104 need not communicate over an unprotected network (such as the internet) to access spaciotemporal data server 118.

Depending upon the particular embodiment of system 100 and/or the current state of system 100, an information source that provides item data to a user device may (by need not) reside within the same security domain as the user device. As one example, the information source resides within a classified network domain, and the user device resides within an unclassified network domain. As another example, the information source resides within an unclassified network domain, and the user device resides within a classified network domain. Alternatively, the information source and the user device may both reside within classified network domains, or the information source and the user device may both reside within unclassified network domains.

Secure network server 106 is coupled to networks 102/104 and, therefore, secure network server 106 is also coupled to the individual devices and components within networks 102/104. Secure network server 106 acts as a gateway to route and filter data exchanged between network 102 and the outside world, between network 104 and the outside world, and between network 102 and network 104. Secure network server 106 is suitably configured to route data (e.g., item data as described below) from information sources within system 100 in accordance with the particular security protocol(s) that govern the data. Accordingly, secure network server 106 includes the processing capability and memory required to maintain and resolve the different security protocols applied to data passing between the networks of system 100. Techniques and technologies that may be implemented by secure network server 106 and/or other elements within system 100 are described in U.S. patent application Ser. No. 11/434,313, titled Multiple Level Security Adapter, the content of which is incorporated herein by reference.

FIG. 2 depicts additional features and elements of system 100 that are not shown in FIG. 1. For example, FIG. 2 illustrates an information broker/proxy 150 associated with network 102 and an information broker/proxy 152 associated with network 104. FIG. 2 also schematically illustrates that any number of additional networks 107 and respective information brokers/proxies 153 may be included in a deployment of system 100. For this embodiment, information broker/proxy 150 is coupled between network 102 and secure network server 106, and information broker/proxy 152 is coupled between network 104 and secure network server 106. In practice, information broker/proxy 150 may be considered to be a part of network 102. Likewise, information broker/proxy 152 may be considered to be a part of network 104. Again, secure network server 106 operates such that it only routes data between networks (or network users) that have permissions to view the data, based on the managed security protocols, classification levels, etc. The information brokers/proxies are utilized to manage the routing of data, which need not be consistently and compatibly formatted, through secure network server 106. The information brokers/proxies allow secure network server 106 to effectively and efficiently integrate information from networks of different security domains having disparate security protocols associated therewith. In this regard, the information brokers/proxies act as translators to reformat information as needed; the information brokers/proxies are specifically configured and written for compatibility with the known security domains and data formats handled by system 100. Techniques and technologies that may be implemented by the information brokers/proxies are described in U.S. patent application Ser. No. 11/434,313, titled Multiple Level Security Adapter, the content of which is incorporated herein by reference.

As shown in FIG. 2, network 102 may include various databases, servers, computer-executable software modules, processing architectures, and the like, which may be distributed throughout network 102 in any number of different ways. In the illustrated example, network 102 includes a spaciotemporal visualization component 154, an information integrator 156 for dynamic data, a static spaciotemporal information database 158, a database 160 containing information relating to items of interest, and an item of interest database 162. Here, spaciotemporal visualization component 154 is coupled to information integrator 156 and to spaciotemporal information database 158, and information integrator 156 is coupled to database 160 and to item of interest database 162. Of course, a different interconnection architecture, combined databases, and other variations to network 102 may be realized in a practical embodiment.

For this particular embodiment, spaciotemporal visualization component 154 is realized as a client software application that resides at a user device within network 102. Thus, an instantiation of spaciotemporal visualization component 154 appears at each user device having the spaciotemporal GUI capabilities described herein. In practice, spaciotemporal visualization component 154 may include, be realized as, or represent a modified version of a virtual globe program or service, a map program or service, or a navigation program or service. For example, spaciotemporal visualization component 154 may leverage applications, programs, and/or services such as, without limitation: the Google Earth application, the MapPoint application by Microsoft, the TerraServer application by Microsoft, the World Wind application developed by NASA, ArcGIS, the Virtual Earth application by Microsoft, or the like. Spaciotemporal visualization component 154 generates displays of geography for rendering at an electronic display of the host user device. Spaciotemporal visualization component 154 is preferably configured to present a realistic rendering of any location by superimposing images obtained from satellite imagery, aerial photography and geographic information systems over a three dimensional interactive globe. In lieu of (or in addition to) photographic images, spaciotemporal visualization component 154 may present drawings or other non-photographic graphical depictions of geography. A user can interact with spaciotemporal visualization component 154 to zoom in and out, pan, tilt, roll, and/or otherwise change the view that is currently displayed. Certain aspects of the operation and feature set of spaciotemporal visualization component 154 are shared by several well known applications (such as the Google Earth program), and such shared aspects will not be described in detail herein.

As mentioned above, spaciotemporal visualization component 154 may be executed by a user device within network 102. Static spaciotemporal information database 158, which may be realized using one or more physical components, contains static information associated with spaciotemporal characteristics of areas of interest processed by system 100. As used herein, such static information corresponds to data, images, and/or graphics that do not dynamically change in real time (at least over the relatively brief time periods of interest). For example, static spaciotemporal information may be used to describe the permanent location of mountains, countries, bridges, states, buildings, roads, and other items that do not usually move, and static spaciotemporal information database 158 may contain photographs of such static elements, graphical representations of such static elements or concepts represented by such elements, location or navigation data related to the position of such static elements, descriptive content about such static elements, or the like. Static spaciotemporal information database 158 need not contain dynamically changing information handled by system 100, for example, data associated with moving objects or dynamic descriptive information associated with stationary objects.

Static spaciotemporal information database 158 may reside locally at the host user device, it may reside elsewhere in network 102, and/or it may be realized in the form of a portable memory storage device or media. As described above with reference to FIG. 1, unclassified network 102 can access static spaciotemporal information database 158 via the internet. In contrast, classified network 104 accesses a protected static spaciotemporal database that resides within the confines of the security domain for classified network 104.

Information integrator 156, which may be realized as a computer-executable software module, functions to integrate the static spaciotemporal information with additional information associated with items of interest being monitored by system 100. In particular, information integrator 156 merges dynamic item data with static spaciotemporal data. In this regard, FIG. 2 depicts information integrator 156 in communication with database 160 and in communication with item of interest database 162. For this particular embodiment, information integrator 156 is realized as a module that resides at a user device within network 102. Thus, an instantiation of information integrator 156 appears at each user device having the spaciotemporal GUI capabilities described herein.

In operation, information integrator 156 receives data in a desired format from database 160 and/or from item of interest database 162. Information integrator 156 can then process and reformat the received data as needed such that the received data can be integrated with the static spaciotemporal data for purposes of GUI rendering. In practice, information integrator 156 may be suitably configured to cooperate with GUI generation logic and/or a display driver of the host user device to facilitate the display of the integrated information. As an example, it may generate the spaciotemporal view of all aggregated data in a standard format, such as the Keyhole Markup Language (KML) format supported by the Google Earth application for rendering spaciotemporal data layers.

Item of interest database 162 may reside locally at the host user device, it may reside elsewhere in network 102, and/or it may be realized in the form of a portable memory storage device or media. In practice, database 160 and item of interest database 162 may be combined into a common database or a common distributed database. Item of interest database 162, which may be realized using one or more physical components, represents an information source that provides item data related to items of interest, where the item data may be governed by one or more security protocols as previously discussed. The item data contained in item of interest database 162 may have originated from disparate security domains corresponding to different originating networks, and secure network server 106 can operate to grant access to such item data in accordance with the security credentials of an authenticated user, and in accordance with different security protocols utilized by the disparate security domains. Thus, secure network server 106 can filter item data according to any data filtering criteria for the user.

Item of interest database 162 contains information related to items of interest that are monitored and/or processed by system 100. Item of interest database 162 may contain data that identifies, locates, tracks, describes, and/or defines the items of interest. For example, item of interest database 162 may contain data that represents any of the following information, without limitation: photographs of the items of interest; graphical representations of the items of interest; location, tracking, or navigation data related to the position of the items of interest; names and/or identifiers of the items of interest; or the like. Notably, any given data element contained in item of interest database 162 may be dynamic in nature or static in nature. For example, if an item of interest is a moving object, then item of interest database 162 may include current location/tracking information for that moving object and the GUI at the host user device can render an icon that represents that moving object in response to the current location/tracking information, where the icon is superimposed on the spaciotemporal rendering of the area of interest.

Database 160 may reside locally at the host user device, it may reside elsewhere in network 102, and/or it may be realized in the form of a portable memory storage device or media. Database 160, which may be realized using one or more physical components, represents an information source that provides item data related to items of interest, where the item data may be governed by one or more security protocols as previously discussed. The item data contained in database 160 may have originated from disparate security domains corresponding to different originating networks, and secure network server 106 can operate to grant access to such item data in accordance with the security credentials of an authenticated user, and in accordance with different security protocols utilized by the disparate security domains. Thus, secure network server 106 can filter item data according to any data filtering criteria for the user.

Database 160 may be (or include) a collaborative content database for the user device, where database 160 contains user-generated information about items of interest that are monitored and/or processed by system 100. Thus, database 160 may contain data corresponding to the items of interest that can be shared by the different users of system 100. For this embodiment, database 160 may contain data that represents any of the following information, without limitation: user blogs; wiki entries; audio recordings; video clips; instant messages; emails; data captured or generated by items of interest (e.g., sensor data or radar data); images; open source data; relationship to other item(s) of interest; or the like. In practice, database 160 allows users of system 100 to make contributions (i.e., new entries) and view existing entries corresponding to the items of interest, thus enhancing the effectiveness of the collaborative information sharing capability of system 100. Consequently, any given data element contained in database 160 may be updateable or static in nature.

Notably, information integrator 156 may also be configured to populate database 160 and/or item of interest database 162 in response to user interaction with spaciotemporal visualization component 154, the displayed GUIs, the user device, or other elements of system 100. For example, system 100 may allow a user to create a blog, upload pictures, or create a wiki entry for an item of interest using one or more available techniques and technologies. Information integrator 156 can then process the user-generated data and make it available for storage at database 160 or item of interest database 162.

Other than the differences mentioned above with reference to FIG. 1, network 104 may be similarly configured. Moreover, the other networks 107 in system 100 may also be generally configured as described here for network 102. Thus, data maintained by database 160 and item of interest database 162 can be shared, via secure network server 106, with networks 104/107 in system 100.

System 100 generates GUIs for presentation to its end users, where a given GUI contains a spaciotemporal rendering of an area of interest, along with icons that represent items of interest superimposed on the spaciotemporal rendering. For a given end user, system 100 can render a GUI on an electronic display of a suitably configured electronic device. In practice, the user device is coupled to secure network server 106, and the user device is configured to receive the item data from secure network server 106 upon successful user authentication (which determines applicable security protocols for the authenticated user and, in turn, data filtering for the user device).

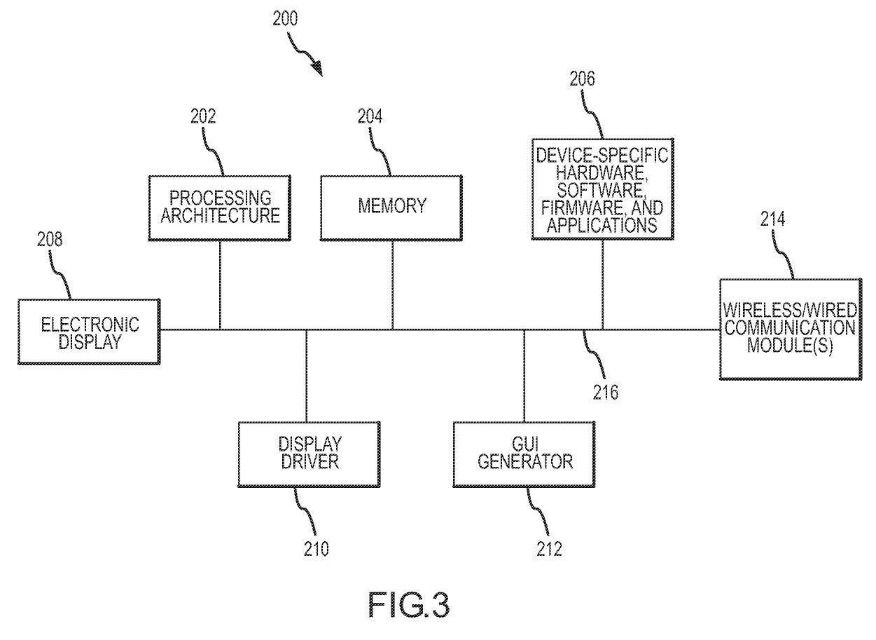

FIG. 3 is a schematic representation of an embodiment of an electronic device 200 that is suitable for use with a collaborative information sharing system such as system 100. Electronic device 200, which may assume any practical form factor, includes or communicates with at least one electronic display for rendering GUIs as described below. For example, electronic device 200 may be realized as any of the following devices, without limitation: a personal computer (desktop, laptop, palmtop, wearable, or the like); a wireless computing device; a cellular telephone; a personal digital assistant; or a digital media player.

Referring to FIG. 3, electronic device 200 may include, without limitation: a processing architecture 202; a suitable amount of memory 204; device-specific hardware, software, firmware, and applications 206; an electronic display 208; a display driver 210; a GUI generator 212; and wireless/wired communication module(s) 214. The elements of electronic device 200 may be coupled together via a bus 216 or any suitable interconnection architecture. Those of skill in the art will understand that the various illustrative blocks, modules, circuits, and processing logic described in connection with electronic device 200 may be implemented in hardware, computer software, firmware, or any combination of these. To clearly illustrate this interchangeability and compatibility of hardware, firmware, and software, various illustrative components, blocks, modules, circuits, and processing steps may be described generally in terms of their functionality. Whether such functionality is implemented as hardware, firmware, or software depends upon the particular application and design constraints imposed on the embodiment. Those familiar with the concepts described here may implement such functionality in a suitable manner for each particular application, but such implementation decisions should not be interpreted as causing a departure from the scope of the invention.

Processing architecture 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

Memory 204 may be realized as RAM memory, flash memory, EPROM memory, EEPROM memory, registers, a hard disk, a removable disk, a CD-ROM, or any other form of storage medium known in the art. In this regard, memory 204 can be coupled to processing architecture 202 such that processing architecture 202 can read information from, and write information to, memory 204. In the alternative, memory 204 may be integral to processing architecture 202. As an example, processing architecture 202 and memory 204 may reside in an ASIC. Referring again to FIG. 2, the data in static spaciotemporal information database 158 or a portion thereof, the data in database 160 or a portion thereof, and/or the data in item of interest database 162 or a portion thereof may be stored in memory 204 in certain implementations of system 100.

Device-specific hardware, software, firmware, and applications 206 may vary from one embodiment of electronic device 200 to another. For example, device-specific hardware, software, firmware, and applications 206 can support conventional personal computer functions when electronic device 200 is realized as a personal computer. Notably, device-specific hardware, software, firmware, and applications 206 may include a spaciotemporal visualization component and/or an information integrator as described above with reference to FIG. 2. In practice, certain portions or aspects of device-specific hardware, software, firmware, and applications 206 may be implemented in one or more of the other blocks depicted in FIG. 3.

Electronic display 208 is suitably configured to enable electronic device 200 to render and display GUIs having the characteristics and features described herein. Of course, electronic display 208 may also be utilized for the display of other information, and electronic display 208 may be realized with any known computer monitor technology. In practice, electronic display 208 is coupled to display driver 210, which controls and manages the rendering of graphical information on electronic display 208. Notably, the specific configuration, operating characteristics, size, resolution, and functionality of electronic display 208 and display driver 210 can vary depending upon the practical implementation of electronic device 200. For example, if electronic device 200 is a desktop computer, then electronic display 208 may be a CRT, LCD, or plasma monitor. Alternatively, if electronic device 200 is a personal digital assistant, then electronic display 208 may be a small scale integrated LCD, which may include a stylus writing screen, a touchpad, or the like.

GUI generator 212 can be realized as processing logic, and such processing logic may be realized as one or more pieces of software/firmware. For example, GUI generator 212 may be partially or wholly implemented in processing architecture 202, display driver 210, and/or in device-specific hardware, software, firmware, and applications 206. For the embodiments described here, GUI generator 212 may be realized as processing logic configured to dynamically generate graphical elements for display on electronic display 208, including the spaciotemporal-based GUIs described herein. In this regard, GUI generator 212 produces GUIs that are influenced by the item data associated with the displayed items of interest. To support real time or near real time operation, GUI generator 212 is suitably configured to update GUIs whenever electronic device 200 receives fresh item data. In certain embodiments, the graphical elements produced by GUI generator 212 are processed by display driver 210 for rendering on electronic display 208.

An embodiment of electronic device 200 may employ any number of wireless data communication modules and/or any number of wired data communication modules (identified by reference number 214). These data communication modules are suitably configured to support wireless/wired data communication (unidirectional or bidirectional, depending upon the particular implementation) between electronic device 200 and other compatible devices, for example, other network devices within the security domain of electronic device 200.

A wireless data communication module is configured to support one or more wireless data communication protocols. Any number of suitable wireless data communication protocols, techniques, or methodologies may be supported by electronic device 200, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. In an embodiment of electronic device 200, a wireless data communication module may include or be realized as hardware, software, and/or firmware, such as an RF front end, a suitably configured radio module (which may be a stand alone module or integrated with other or all functions of the device), a wireless transmitter, a wireless receiver, a wireless transceiver, an infrared sensor, an electromagnetic transducer, or the like. Moreover, electronic device 200 may include one or more antenna arrangements that cooperate with the wireless data communication module.

A wired data communication module supports data transfer over a cable, a wired connection, or other physical link. A wired data communication module is configured to support one or more wired/cabled data communication protocols. Any number of suitable data communication protocols, techniques, or methodologies may be supported by electronic device 200, including, without limitation: Ethernet; home network communication protocols; USB; IEEE 1394 (Firewire); hospital network communication protocols; and proprietary data communication protocols. In an embodiment of electronic device 200, a wired data communication module may include or be realized as hardware, software, and/or firmware, such as a suitably configured and formatted port, connector, jack, plug, receptacle, socket, adaptor, or the like.

An embodiment of electronic device 200 is suitably configured to render the spaciotemporal GUIs described here, regardless of the form factor, native GUI capabilities, display resolution, and graphics rendering capabilities of electronic device 200. In this regard, FIGS. 5-10 depict exemplary GUIs generated by a collaborative information sharing system such as system 100. It should be appreciated that, in operation, the GUIs may be presented in an interactive and dynamic manner rather than a series or sequence of individual screens as depicted herein. For example, in a personal computer implementation, the user can navigate a graphical pointer (e.g., a mouse arrow) over the GUIs as needed to support various interactive features, and the spaciotemporal rendering may smoothly transition in response to such user interaction or in response to other multi-dimensional user interface, such as data gloves or spatial navigation devices.

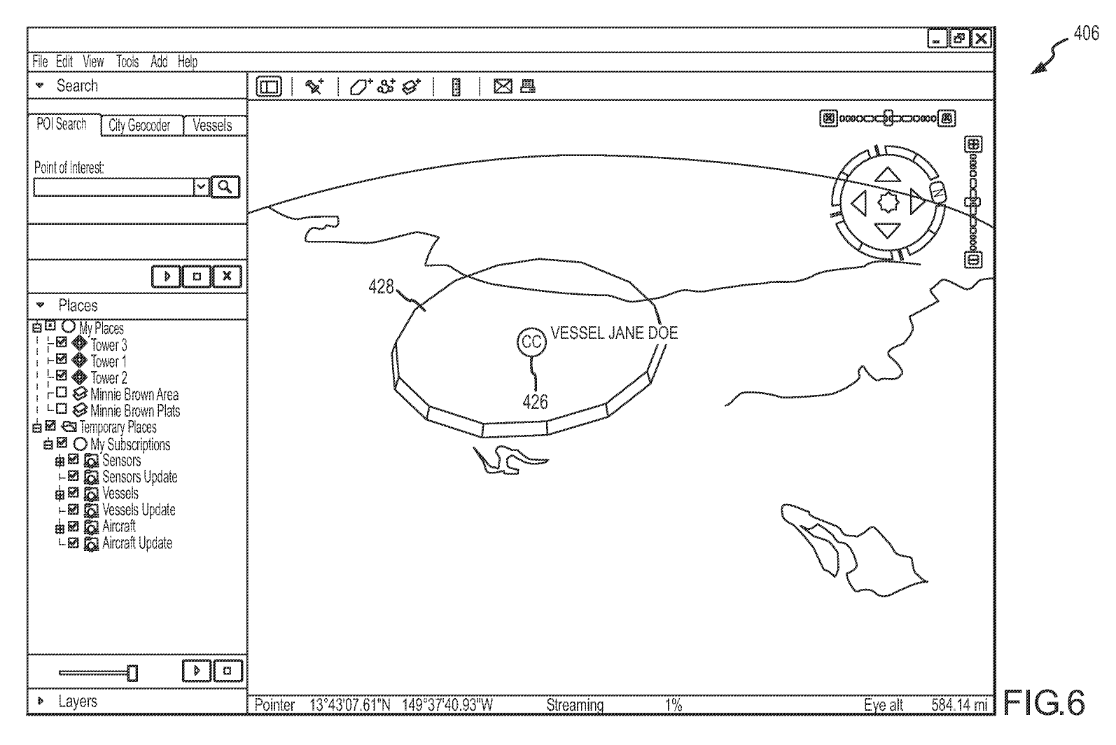

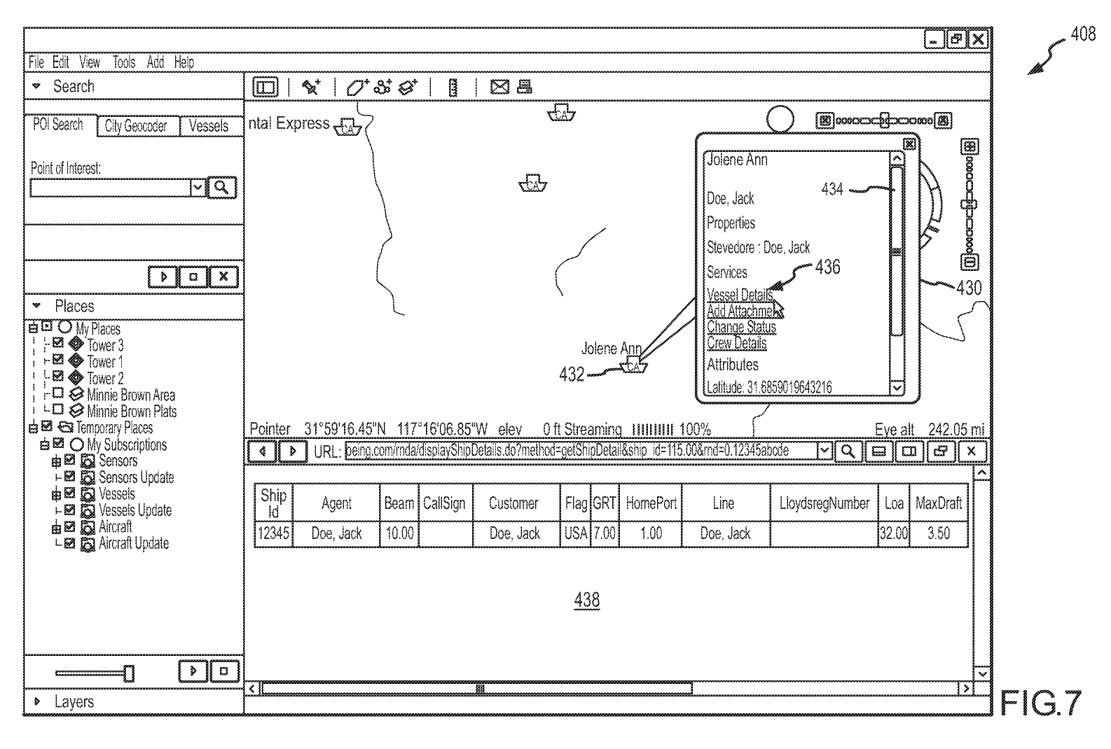

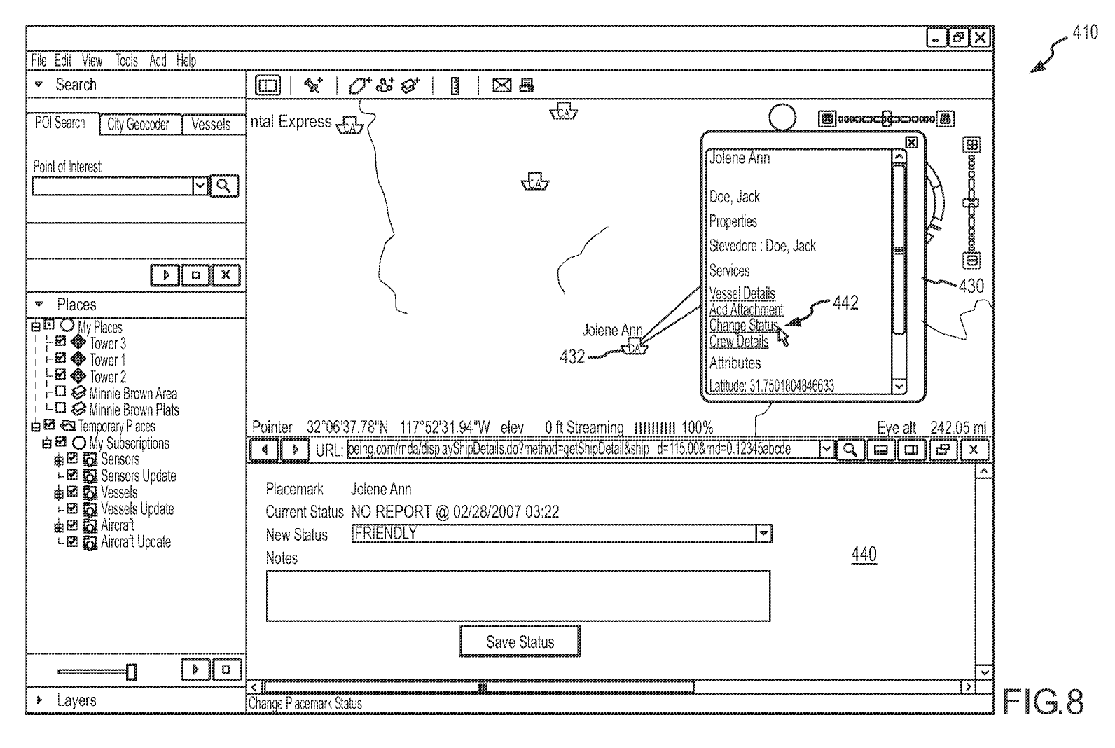

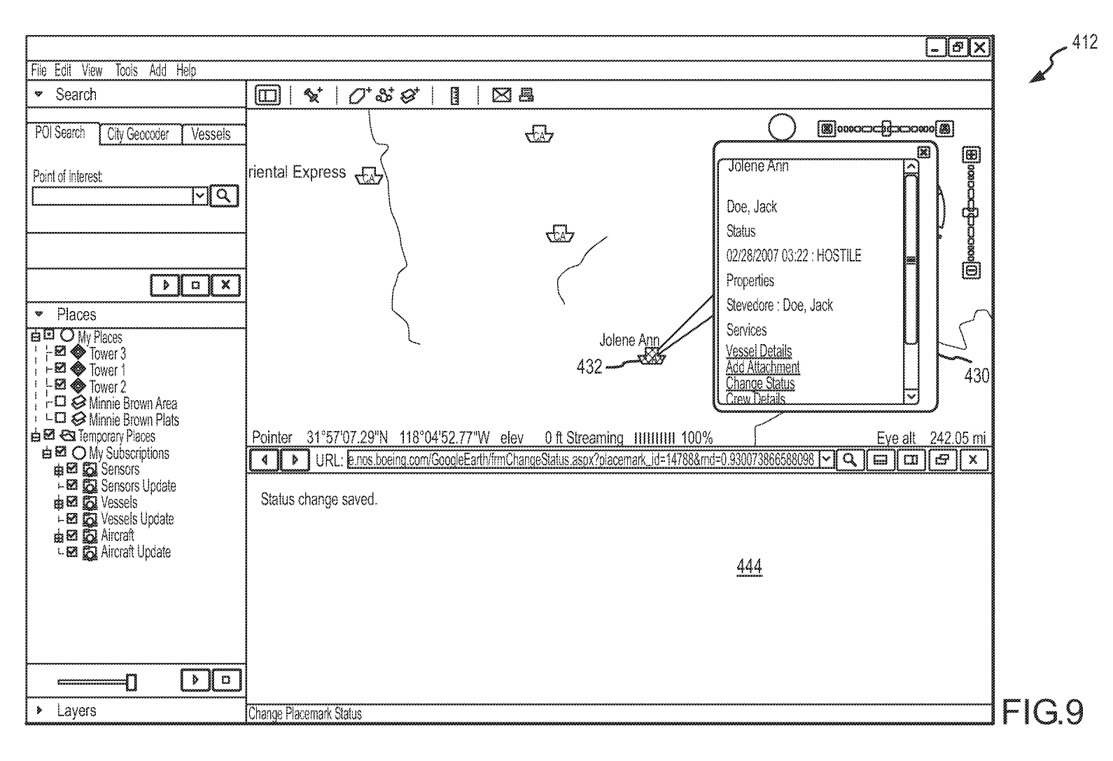

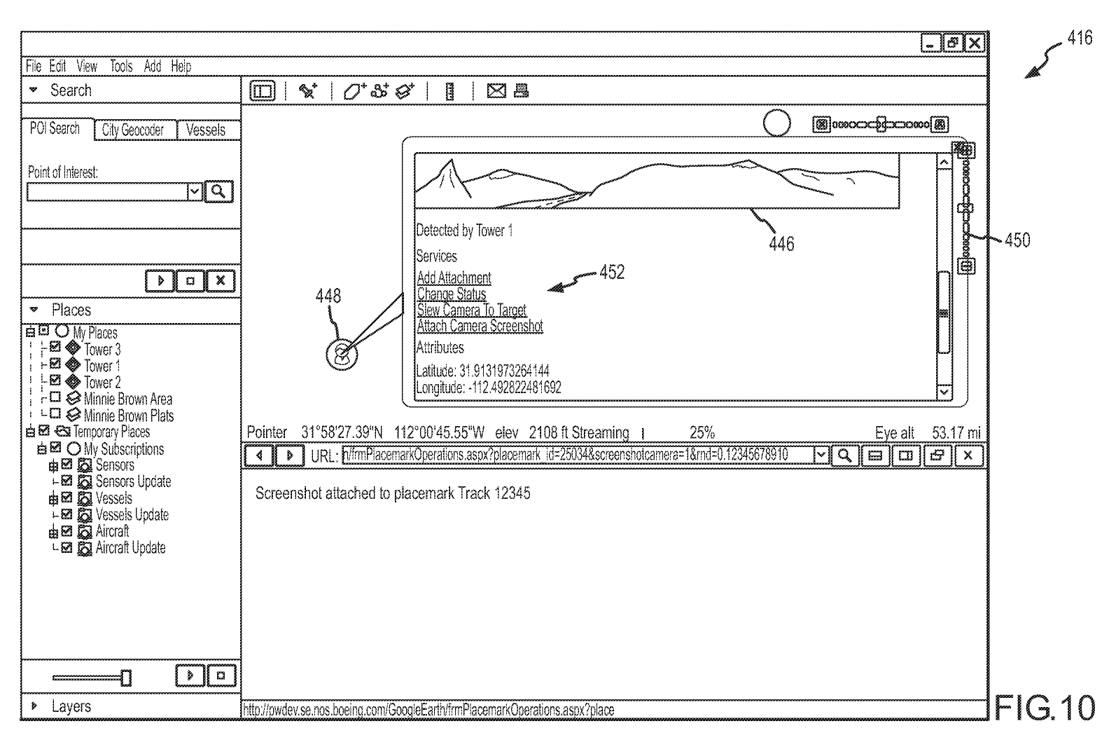

For illustrative purposes, a number of GUIs are depicted herein as screen shots; these specific screen shots are not intended to limit or otherwise restrict the application or scope of the subject matter disclosed herein. FIG. 5 depicts a GUI 400 that includes the primary graphical components: a spaciotemporal rendering 402 and a plurality of icons 404; FIG. 6 depicts a GUI 406 that focuses on one item of interest; FIG. 7 depicts a GUI 408 that includes a pop-up window for an icon; FIG. 8 depicts a GUI 410 that includes a data entry field for an icon; FIG. 9 depicts a GUI 412 that reflects an updated status for an icon; and FIG. 10 depicts a GUI 414 that includes a shared photograph. In practice, some or all of the constituent parts of the GUIs depicted in FIGS. 5-10 can be enabled/disabled by a user to customize the appearance of the displayed content. These GUIs provide the user with a simple and intuitive spaciotemporal rendering of an area of interest in association with icons that represent items of interest located within the displayed area of interest. Moreover, the GUIs can also display (or provide access to) other usable information, such as collaborative content about the items of interest. In certain embodiments, the GUIs also provide the user with the capability to access services associated with the items of interest (such services are described in more detail below).

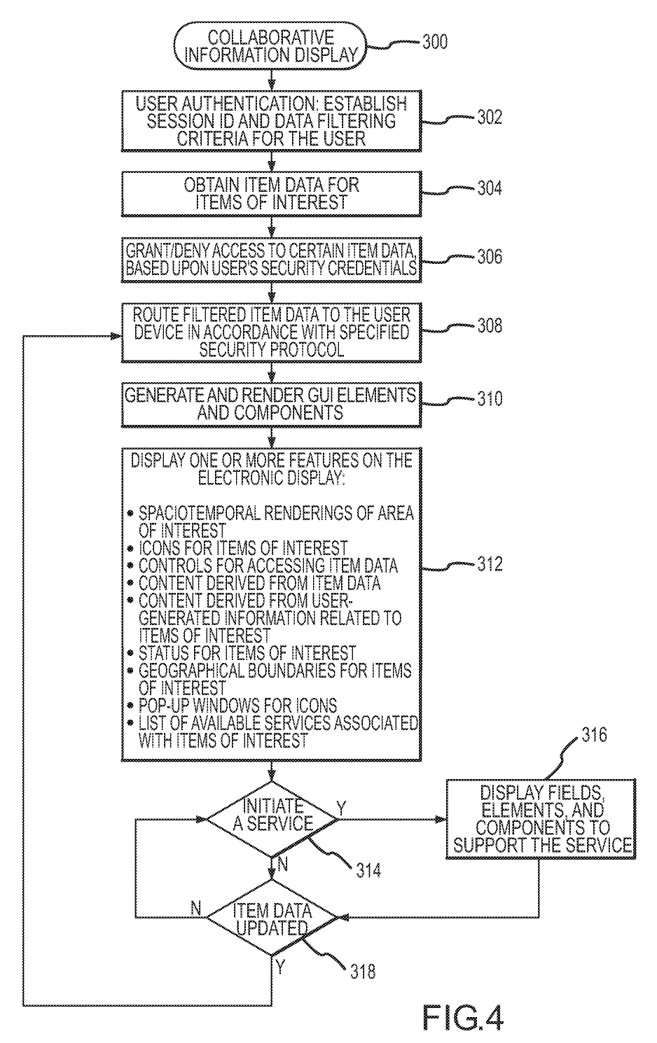

The GUIs described herein may be generated and rendered in connection with any desired application and deployment. In this regard, FIG. 4 is a flow chart that illustrates a collaborative information display process 300 that might be carried out by an information sharing system such as system 100. Process 300 corresponds to a method of displaying graphical representations of items of interest to facilitate collaborative information sharing for the items of interest. The various tasks performed in connection with process 300 may be performed by software, hardware, firmware, or any combination thereof. For illustrative purposes, the following description of process 300 may refer to elements mentioned above in connection with FIGS. 1-3. In practice, portions of process 300 may be performed by different elements of the described system, e.g., secure network server 106, GUI generator 212, display driver 210, or electronic display 208 (FIG. 3). It should be appreciated that process 300 may include any number of additional or alternative tasks, the tasks shown in FIG. 4 need not be performed in the illustrated order, and process 300 may be incorporated into a more comprehensive procedure or process having additional functionality not described in detail herein.

For a given user, process 300 may begin by authenticating the user of a device (task 302). Task 302 may employ an authentication technique or protocol such as: digital certificates; smart badges; biometrics; or usernames/passwords. In certain embodiments, task 302 carries out a “single sign on” process such that the user need not individually log in to gain authenticated access to the different databases, services, networks, and/or resources leveraged by the system. For example, based upon the login credentials of the user, the system may generate a unique session identifier that is thereafter utilized to authenticate subsequent user requests. The session identifier is uniquely linked to the authenticated user in a way that allows the system to determine what permissions and security protocols to enforce for that particular user. In this regard, process 300 uses the authentication procedure to establish data filtering criteria for the user. Such data filtering will allow the user to view permitted information, while restricting access to protected information. When carried out for a plurality of users, such data filtering allows the system to support different users having different security classifications, and networks in disparate security domains.

After authenticating the user, process 300 can generate an initial GUI that includes a spaciotemporal rendering of an area of interest, along with icons that represent items of interest within the area. GUI 400 (FIG. 5) is an example of such an initial GUI. In connection with the display of such a GUI, process 300 obtains item data related to the items of interest (task 304). For the embodiment described above, secure network server 106 obtains the item data, which may originate from disparate security domains. Notably, however, all of the item data available within the system need not be provided to the user device. Accordingly, the system may grant/deny access to available item data in accordance with the security credentials of the authenticated user (task 306). In this regard, the system may grant/deny access to item data in accordance with potentially different security protocols utilized by the disparate security domains. For the embodiment described above, secure network server 106 grants or denies access to the available item data such that the item data for the given user (and for the given user device) satisfies any data filtering criteria that has been established for the authenticated user.

Process 300 may then route or otherwise transfer the “filtered” item data to the authenticated user device (task 308). This may be performed on an as-needed or as-requested basis, and in accordance with the specified security protocol for the user. As mentioned above, a security protocol might correspond to a classified/unclassified status for the item data. In response to the item data, process 300 generates, for display on the host electronic device, a suitably formatted GUI having the desired features, display characteristics, elements, components, and functionality (task 310). The generated graphical element may then be rendered (task 310) on the electronic display. Accordingly, the GUI will be influenced by the item data obtained and processed by the user device. In connection with such rendering, process 300 will display one or more graphical features, items, and components on the electronic display (task 312). For example, task 312 may display on the electronic display any of the following features, individually or in any desired combination: a spaciotemporal rendering of an area of interest; icons representing the items of interest; a graphical control for accessing item data; graphical content corresponding to or derived from item data; graphical content corresponding to or derived from user-generated information related to items of interest; status information for items of interest; geographical boundaries associated with items of interest, and visually distinguishable characteristics thereof, pop-up windows for icons, and content related to the respective items of interest displayed within the pop-up windows; lists of available services associated with items of interest; any additional GUI feature or element described herein; and possibly other GUI features, elements, or components.

The system may display a list of available services for an item of interest in any suitable manner, including rendering a list in a pop-up window corresponding to the item of interest. Services for an item of interest include, without limitation: providing details about the item of interest; adding/uploading file attachments for the item of interest; changing the status of the item of interest; providing crew/personnel details for the item of interest; executing remote commands for the item of interest; executing open or restricted collaborative services; or the like. In this regard, if the user initiates a service (query task 314), then process 300 may display one or more fields, elements, and components as needed to support the initiated service (task 316). These displayed features may be used to display information to the user, to provide data entry fields for the user, to provide interactive communication tools to the user (e.g., a blog entry field, an instant message text field, or a live chat screen), or the like. In practice, a user of the host electronic device can activate a service using, for example, a touch screen upon which the control button field is rendered, a touchpad, a mouse, a keyboard or a keypad in conjunction with a displayed soft key feature, or the like. After initiation of the service, the system can carry out any requested operations and update the item data as needed. If the item data has not been updated (query task 318), then process 300 may be re-entered at, for example query task 314. In other words, process 300 may idle until a service is initiated or the item data is updated. When the item data is updated (query task 318), process 300 may be re-entered at, for example, task 308. This enables process 300 to obtain the updated item data and, in response thereto, update the GUI rendered on the host device if necessary. In this manner, the GUI can be continuously (or periodically) refreshed during normal operation of the host device to provide a real time (or near real time) visual display of the monitored items of interest.

Referring again to FIG. 5, GUI 400 includes a primary section 418 that corresponds to the boundary of spaciotemporal rendering 402, and a secondary section 420 that includes various tabs, data entry fields, and other information. At this particular level of zoom, spaciotemporal rendering 402 depicts a relatively expansive view of the United States within a specific timeframe. GUI 400 may include any number of icons 404 superimposed on (and located within the boundary of) spaciotemporal rendering 402, where each icon represents a different item of interest. This rendering may also support conceptual constructs depicting structures rendered to provide grouping, thematic reference, or other context to displayed information. To accommodate the display of a high density of icons, the GUI may be rendered such that neighboring icons or portions thereof overlap each other. If an icon represents a stationary object such as a building or a bridge, then it need not have dynamically updateable location information associated therewith. On the other hand, if an item of interest is a moving object such as an aircraft or a train, then the respective item data may include current location information for that moving object. Accordingly, displaying a movable icon will be responsive to the current location information obtained by the system. In other words, the displayed position of the icon will vary in time, relative to a stationary reference such as a geographical boundary line or a mountain.

In practice, the appearance of a given icon may indicate the type or category of the item of interest (e.g., the icon may resemble a ship, an aircraft, a building, or a radar antenna). As shown in FIG. 5, a GUI may also display text labels near the icons, where a text label may include a name, an ID, or other alphanumeric information for the respective item of interest. These text labels may be rendered with the icons, or they may be rendered only when the user focuses a pointing device on or over an icon. Moreover, a given icon may be displayed with visually distinguishable characteristics that indicate a current status, operating condition, or feature of the respective item of interest. For example, the icon itself and/or the text label of the icon may be displayed using a certain color, brightness, pattern or shading, or flashing pattern, where different characteristics are used to represent a different status. For instance, a green colored ship icon may indicate that the monitored item of interest is a “friendly” ship, a red colored ship icon may indicate a “hostile” ship, and a yellow colored ship icon may indicate a ship of unknown or neutral relationship.

Secondary section 420 may include an area 422 that allows the user to identify one or more items of interest that are of particular importance. FIG. 5 depicts these identified items of interest under the heading “My Places.” Secondary section 420 may also include an area 424 that allows the user to select or identify information sources to which he or she has access. In other words, the user's security credentials and the current session ID of the system permit the user to view data for items of interest that fall under certain categories. FIG. 5 depicts these information sources and categories under the heading “My Subscriptions.” In practice, the user can select items listed in area 424 (using the checkboxes) to control which types and categories of icons are displayed. This feature allows the user to simplify the GUI as needed. For instance, the user may configure the GUI such that only ships and aircraft are displayed.

Referring to FIG. 6, GUI 406 focuses on one item of interest, namely, a sensor, an antenna, or any item of interest having a geographical boundary associated therewith. The geographical boundary may be, without limitation: a property line associated with real property; an operating range of a radar antenna or other sensor; a transmission range of a cellular base station; the range of a sonar system; or the like. Here, the item of interest is represented by an icon 426, along with a boundary 428 that indicates the geographical boundary of the item of interest. The GUI may display icon 426 and/or boundary 428 with visually distinguishable characteristics that indicate the current geographical boundary. For example, if the item of interest is available but not currently in an operating condition (e.g., radar on standby and not radiating), then the area may be colored yellow. In contrast, if the boundary represents an operating condition, then the area may be colored green. In certain embodiments, boundary 428 can be generated as a three-dimensional volume that graphically represents an estimated three-dimensional coverage area of the item of interest. A volume may be depicted as a cone, a sphere, a half-sphere, or the like, and the scale of the rendered volume may approximate the actual coverage area.

Referring to FIG. 7, GUI 408 includes a pop-up window 430 for an icon 432. In this regard, the system can display such pop-up windows in response to user interaction with the icons. For example, pop-up window 430 may be launched if the user selects icon 432 with a pointing device (e.g., a mouse arrow), if the user hovers the pointing device over icon 432, or if the user selects a “show pop-up windows” option. Pop-up window 430 may contain or provide access to information related to the item of interest represented by icon 432, including, without limitation: a graphical element associated with the item data; content derived from the item data; a list of available services associated with the item of interest; a control or link for accessing the item data; identifying data for the item of interest; or operational status data for the item of interest. As depicted in FIG. 7, pop-up window 430 may include an interactive scroll bar 434 to enable the user to view all of the contents in pop-up window 430.

As mentioned above, the system integrates external data sources within the spaciotemporal-based GUI, but the user can only view certain types and classes of information. GUI 408 illustrates a condition where the user has authorized access to the “Vessels” information source, and where the user has activated the “Vessels Details” link 436 in pop-up window 430. Here, the “Vessels Details” link 436 initiates a service that accesses the external data source that contains information about the particular item of interest (the ship named Jolene Ann in this example). For this particular embodiment, the data obtained via the “Vessels Details” link 436 is displayed in an area 438, which reduces the displayed area of spaciotemporal rendering 402. As shown in FIG. 7, area 438 may include descriptive and status data related to the ship named Jolene Ann.

FIG. 8 depicts a GUI 410 that includes a data entry field 440 for icon 432. GUI 410 illustrates a condition where the user has activated the “Change Status” link 442 in pop-up window 430. Here, the “Change Status” link 442 initiates a service that allows the user to alter the current status of the item of interest (the ship named Jolene Ann in this example). For this particular embodiment, the user can manipulate a dropdown menu to change the status from “Friendly” to “Hostile” and save the updated status such that the updated status can propagate through the system for viewing by other shared users.

FIG. 9 depicts a GUI 412 that reflects the updated status for icon 432. In lieu of data entry field 440, GUI 412 displays a confirmation field 444 that includes the text “Status change saved.” Notably, in FIG. 8 the color or shade of icon 432 identifies the Jolene Ann as a friendly ship, while in FIG. 9 the color or shade of icon 432 has changed to identify the Jolene Ann as a hostile ship.

FIG. 10 depicts a GUI 416 that includes a shared photograph 446. Here, an icon 448 represents a sensor or other equipment that includes a camera. A pop-up window 450 for icon 448 includes a list of services 452. One of these services allows the user to remotely control the camera using the GUI generated by the system. This service is labeled “Slew Camera To Target” in FIG. 10. Another service allows the user to capture a photograph with the camera, and to attach/upload the photograph to the collaborative information sharing system. This service is labeled “Attach Camera Screenshot” in FIG. 10. Photograph 446 represents a photograph captured by the camera in response to remote user control at the user device. Upon uploading of the photograph, the image file (e.g., a JPEG file) can be linked to the item of interest represented by icon 448 such that other users of the system can view the image if desired. GUI 416 demonstrates how management and control services for items of interest can be integrated into the collaborative information sharing GUIs.

A collaborative information sharing system as described herein can be suitably configured to show the current state of relevant information in different parts of the world in a simultaneous manner. The system can be utilized to monitor the real time status of items of interest and to “replay” the state of an area of interest at any given point in time or during any historical period of time by accessing data that has been saved with temporal markers. The system can filter displayed information according to different user security credentials, different network security domains, and, in certain embodiments, depending upon the current state or condition of the monitored items of interest.

The information displayed on a given GUI may be limited to one or more specified latitude/longitude bounding boxes and/or to one or more specified time boundaries. Moreover, the system can utilize role-based access permissions such that a given user can have more than one role. This allows the system to limit geographical regions per user, limit icons per user, limit item of interest types per user, limit services per user, and/or limit properties per user. The system may place a minimally defined set of attributes per icon, with optional properties that can extend the schema as needed. In addition, communications and visualization code can be automatically generated according to the rules and protocols that govern the various databases. Search features of the GUIs provide the ability to search items of interest and icons by latitude/longitude bounding box, time, type or category, name, or attribute type.

Regarding the attachment of files to icons, the system may allow the user to specify a classification/security level for the files and/or specify user roles or types to identify who can view the files. Attachment files can be saved in one or more system databases for viewing by other users according to their access privileges.

Regarding the changing of status of items of interest, the system may maintain a list of valid statuses for each category of the items of interest. In addition, the system may allow the user to specify which users/roles will be able to view a status change. Moreover, the system may allow the user to specify a classification/security level for a status change.

The structure of the collaborative information sharing system described herein allows multiple information sources and data feeds at multiple security levels to be combined into a single GUI and displayed together as interactive icons on a spaciotemporal rendering. The structure automates the connection of the physical entity to associated entries in databases, real time and recorded data feeds, and other electronic forms manually associated therewith. This information is displayed by both altering the displayed icon and by activating the displayed icon.

This combination of information into a single system allows the operator to make rapid assessments regarding the current situational context of a number of items of interest. An operator can quickly and efficiently connect the item's location, speed, and heading to its operator, owner, crew members, declared/suspected contents, previous locations, and the like, and any association of these items to a wide variety of databases and threat assessment techniques. In addition, the structure allows the operator to visually inspect the area for additional resources available to obtain more information to generate actionable intelligence or to carry out requested response functions.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A collaborative information sharing system comprising:
an information source that provides item data related to an item of interest, the item data being governed by a security protocol;
a server coupled to the information source, and configured to route the item data to user devices in accordance with the security protocol; and
a user device coupled to the server, the user device being configured to receive the item data from the server, the user device having rendered thereon a graphical user interface (GUI) that is influenced by the item data, the GUI comprising:
a spaciotemporal rendering of an area of interest; and
an icon, representing the item of interest, superimposed on the spaciotemporal rendering.

2. The collaborative information sharing system of claim 1, the GUI further comprising a graphical element associated with the item data.

3. The collaborative information sharing system of claim 2, wherein the graphical element comprises a control for accessing the item data.

4. The collaborative information sharing system of claim 2, wherein the graphical element comprises content corresponding to the item data.

5. The collaborative information sharing system of claim 1, wherein:
the item of interest is a moving object;
the item data comprises current location/tracking information for the moving object; and
the GUI renders the icon in response to the current location information.

6. The collaborative information sharing system of claim 1, wherein the security protocol corresponds to a classified/unclassified status for the item data.

7. The collaborative information sharing system of claim 1, further comprising a second information source that provides additional item data related to the item of interest, the additional item data being governed by a second security protocol, wherein:
the server is coupled to the second information source, and is configured to route the additional item data to user devices in accordance with the second security protocol;
the user device is configured to receive the additional item data from the server; and
the GUI is further influenced by the additional item data.

8. The collaborative information sharing system of claim 1, further comprising a spaciotemporal database for the user device, the spaciotemporal database containing static information associated with spaciotemporal characteristics of the area of interest.

9. The collaborative information sharing system of claim 1, further comprising a collaborative content database for the user device, the collaborative content database containing user-generated information related to the item of interest.

10. The collaborative information sharing system of claim 1, wherein the information source resides within a classified or otherwise secure network domain, and the user device resides within an unclassified or otherwise non-secure network domain.

11. The collaborative information sharing system of claim 1, wherein the information source resides within an unclassified network domain, and the user device resides within a classified network domain.

12. The collaborative information sharing system of claim 1, wherein the information source and the user device reside within classified network domains.

13. The collaborative information sharing system of claim 1, wherein the information source and the user device reside within unclassified network domains.

14. A method of displaying a representation of an item of interest to facilitate collaborative information sharing for the item of interest, the method comprising:
obtaining item data related to the item of interest, the item data originating from disparate security domains;
granting access to the item data in accordance with security credentials of an authenticated user, and in accordance with different security protocols utilized by the disparate security domains;
generating a spaciotemporal rendering of an area of interest;
generating an icon representing the item of interest; and
rendering a graphical user interface (GUI) on a display of an electronic device, the GUI comprising the spaciotemporal rendering and the icon superimposed on the spaciotemporal rendering, and the GUI being influenced by the item data.

15. The method of claim 14, further comprising generating a graphical control for accessing the item data, wherein rendering the GUI comprises rendering the graphical control on the display of the electronic device.

16. The method of claim 14, further comprising generating graphical content corresponding to the item data, wherein rendering the GUI comprises rendering the graphical content on the display of the electronic device.

17. The method of claim 14, wherein:
the item of interest is a moving object;
obtaining item data comprises obtaining current location/tracking information for the moving object; and
rendering the GUI comprises rendering the icon in response to the current location information.

18. A method of displaying, on an electronic display of a device, a representation of an item of interest to facilitate collaborative information sharing for the item of interest, the method comprising:
authenticating a user of the device to establish a data filtering criteria for the user;
obtaining, at the device, item data related to the item of interest, the item data originating from disparate security domains, and the item data satisfying the data filtering criteria;
displaying, on the electronic display, a spaciotemporal rendering of an area of interest;
displaying, on the electronic display and within the spaciotemporal rendering of the area of interest, an icon that represents the item of interest; and
displaying, on the electronic display, content derived from the item data.

19. The method of claim 18, wherein:
the item of interest is a moving object;
the item data comprises current location/tracking information for the moving object; and
displaying the icon comprises displaying the icon in response to the current location information.

20. The method of claim 18, wherein:
the item data comprises user-generated information related to the item of interest; and
the method further comprises displaying, on the electronic display, content derived from the user-generated information.

21. The method of claim 18, wherein displaying the icon comprises displaying the icon with visually distinguishable characteristics that indicate a current status of the item of interest.

22. The method of claim 18, wherein:
the item of interest has a current geographical boundary associated therewith; and
displaying the icon comprises displaying the icon with visually distinguishable characteristics that indicate the current geographical boundary.

23. The method of claim 18, wherein displaying content comprises displaying a pop-up window for the icon in response to user interaction with the icon, the pop-up window containing the content, and the method further comprises displaying a list of available services associated with the item of interest in the pop-up window.
